(19) United States
(12) Patent Application Publication
(10) Pub. No.: US 2009/0166385 A1
(43) Pub. Date: Jul. 2, 2009

(54) APPARATUS FOR AN ICE DISPENSER

(75) Inventors: Matthew William Davis, Prospect, KY (US); Wayne E. Lawson, LaGrange, KY (US); Russell J. Fallon, Louisville, KY (US); Jeffrey Mellinger, Louisville, KY (US); Bipin Shaha, Louisville, KY (US); William Merritt Nall, Louisville, KY (US); Daniel S. Renz, Louisville, KY (US); Arun Madhav Talegaonkar, Louisville, KY (US); Thomas White, Louisville, KY (US); Anthony Ray Brieschke, Louisville, KY (US); Aaron Williamson, Cosby, TN (US)

Correspondence Address: General Electric Company;GE Global Patent Operation, PO Box 861, 2 Corporate Drive, Suite 648, Shelton, CT, 06484, US

(73) Assignee: General Electric Company, Wilton, CT (US)

(21) Appl. No.: 11/966,183

(22) Filed: Dec. 28, 2007

(51) Int. Cl. B67D 3/00; F25C 5/18

(52) U.S. Cl. 222/504; 62/344; 222/564; 222/146.6

(57) ABSTRACT

In an embodiment of the present invention, a refrigerator with an ice dispenser is shown. The ice dispenser has a user dispense panel. The user dispense panel comprises a dispense control and an ice outlet. A ice storage compartment defines a first interior volume. An ice chute flow connects the ice storage compartment and the ice outlet. The chute comprises a first end in flow communication with the ice storage compartment and a second end in flow communication with the ice outlet. A member is configured between the first and second ends. The member comprises an interior volume in flow communication with the first and second ends. A flow axis is formed from the first end to the second end. The member has a restriction.

### BACKGROUND OF THE INVENTION

This invention relates generally to a refrigerator, and more particularly, to a refrigerator having through the door ice service.

A known refrigerator often contains a freezer compartment, a fresh food compartment or both. The freezer compartment is used to store food and other items at temperatures below zero degrees Celsius while the fresh food compartment is used to store foods and other items at temperatures above zero degrees Celsius.

In one type of known refrigerator 100 a beverage service center 200 is included in the face of one of the compartment doors 108. See FIG. 1. The beverage service center 200 may contain an ice dispenser, cold water, hot water, or a combination of these.

Ice dispensing machines that include mechanisms for dispensing ice into a suitable receptacle are well known in the art. Such mechanisms typically include a solenoid-operated door for regulating the flow of ice from a dispensing chute and for preventing access to the ice storage bin. When open, the door permits the ice to flow under the force of gravity from a dispensing chute that directs the ice into a cup or the like. In one known embodiment, a dispense switch for operating the solenoid is activated by the movement of a lever arm. The solenoid is activated when a cup is placed and held against the lever arm. In another known embodiment, the user positions the cup beneath the chute with one hand while depressing a dispense switch with the other.

The ice dispensing machines typically have a storage container for holding a quantity of ice for use during peak needs. The ice storage bin often contains an auger to mix the ice periodically to prevent individual cubes from freezing together due to defrost cycles. The auger also assists in moving the ice cubes to the ice chute for dispensing. It has been known for users to access the auger when a user reaches in the chute of the ice dispenser to try to free an ice jam. It is desireable in designing ice dispensing systems to minimize the volume occupied by the dispensing system in order to maximize the usable storage volume of the refrigerator. A more compact ice dispensing system may facilitate access to ice crusher blades through the dispenser ice chute.

FIG. 2 shows a prior art cupped hand probe 500 used to determine access to different parts of an ice dispensing apparatus such as dispenser 200. The cupped hand probe 500 has an articulated wrist joint 501 connecting a hand portion 509 and an arm portion 507. Fingers probe 503 projects from hand portion 509. The finger probe 503 may have a series of joints 505 that permit banding of the finger probe 503 similar to a human finger. The hand probe 500 has a point of maximum diameter 510 proximate to wrist 501. This point of maximum diameter 510 often determines the acceptable diameter of an ice-dispensing chute. Standardized sizes for the point of maximum diameter 510 include but are not limited to: 35 mm for a 1.0-1.5 year old child, 37.5 mm for a 3.5-4.5 year old child and 49 mm for a 10.5-11.5 year old child.

FIG. 3 shows a second prior art flat hand probe 600 used to determine access to different parts of an ice dispensing apparatus such as dispenser 200. The flat hand probe 600 has an articulated wrist joint 501 connecting a hand portion 609 and an arm portion 607. Probe 603 projects from hand portion 609. The probe 603 may have a series of joints 605 that permit banding of the finger probe 603 similar to a human finger. The hand probe 600 has a point of maximum width 610 proximate to wrist 601. This point of maximum width often determines the acceptable diameter of an ice-dispensing chute. Standard sizes for the point of maximum width 610 include but are not limited to: 32 mm for a 1.0-1.5 year old child, 44 mm for a 3.5-4.5 year old child and 55 mm for a 10.5-11.5 year old child.

When applied to an ice chute, if one of the probes 500, 600 can be inserted, into the chute and manipulated to reach the auger of the ice dispenser, it is likely a user can become injured, indicating the chute diameter is too large.

FIG. 4 indicates an icemaker configured in door 108 of the freezer compartment 103 of refrigerator 100. A typical arrangement of the icemaker includes an ice forming apparatus 202, and ice bucket 204 and an ice shoot 206 for channeling ice from the ice bucket 204 to an outlet called a funnel at the ice/water dispenser 200 under which a glass or other receptacle may be placed.

However, to permit the flow of ice without constant jamming of ice pieces in the chute a minimum diameter must be maintained. Thus, limiting access to the ice chute and ultimately to the auger by small hands is directly adverse to the free flow of ice during operation of the dispenser.

### DESCRIPTION OF THE INVENTION

As described herein, embodiments of the invention overcome one or more of the above or other disadvantages known in the art.

In an embodiment of the present invention, an ice dispenser is shown. The ice dispenser has a user dispense panel. The user dispense panel comprises a dispense control and an ice outlet. A ice storage compartment defines a first interior volume. An ice chute flow connects the ice storage compartment and the ice outlet. The chute comprises a first end in flow communication with the ice storage compartment and a second end in flow communication with the ice outlet. A member is configured between the first and second ends. The member comprises an interior volume in flow communication with the first and second ends. A flow axis is formed from the first end to the second end. The member has a restriction.

In another embodiment of the present invention, a refrigerator with an ice dispenser is shown. The ice dispenser has a user dispense panel. The user dispense panel comprises a dispense control and an ice outlet. A ice storage compartment defines a first interior volume. An ice chute flow connects the ice storage compartment and the ice outlet. The chute comprises a first end in flow communication with the ice storage compartment and a second end in flow communication with the ice outlet. A member is configured between the first and second ends. The member comprises an interior volume in flow communication with the first and second ends. A flow axis is formed from the first end to the second end. The member has a restriction.

### BRIEF DESCRIPTION OF THE SEVERAL VIEWS OF THE DRAWINGS

The following figures illustrate examples of embodiments of the invention and are not intended to be limiting. The figures are described fully in the detailed description of the invention below.

FIG. 1 is a front perspective view of a side-by-side refrigerator having an ice dispenser according to the present invention.

FIG. 2 shows an Underwriters Laboratories cupped hand probe.

FIG. 3 shows an Underwriters Laboratories flat hand probe.

FIG. 4 is a perspective view of the refrigerator of FIG. 1 with the doors open showing one example of an ice dispenser of FIG. 2 incorporated in the door of the refrigerator.

FIG. 5 is a side cross-sectional view of the ice dispenser of FIG. 2 according to one aspect of the invention.

FIG. 6 is a side cross-sectional view of the ice dispenser of FIG. 2 according to another aspect of the invention.

FIG. 7 is a back cross-sectional view of the ice dispenser of FIG. 2 according to yet another aspect of the invention.

FIG. 8 is a side cross-sectional view of the ice dispenser of FIG. 2 according to yet another aspect of the invention.

FIG. 9 is a side cross-sectional view of the ice dispenser of FIG. 2 according to a further aspect of the invention.

FIG. 10 is a front perspective view of a user dispense panel of the refrigerator of FIG. 1 showing an alternate embodiment of the present invention.

### DETAILED DESCRIPTION OF THE PREFERRED EMBODIMENTS

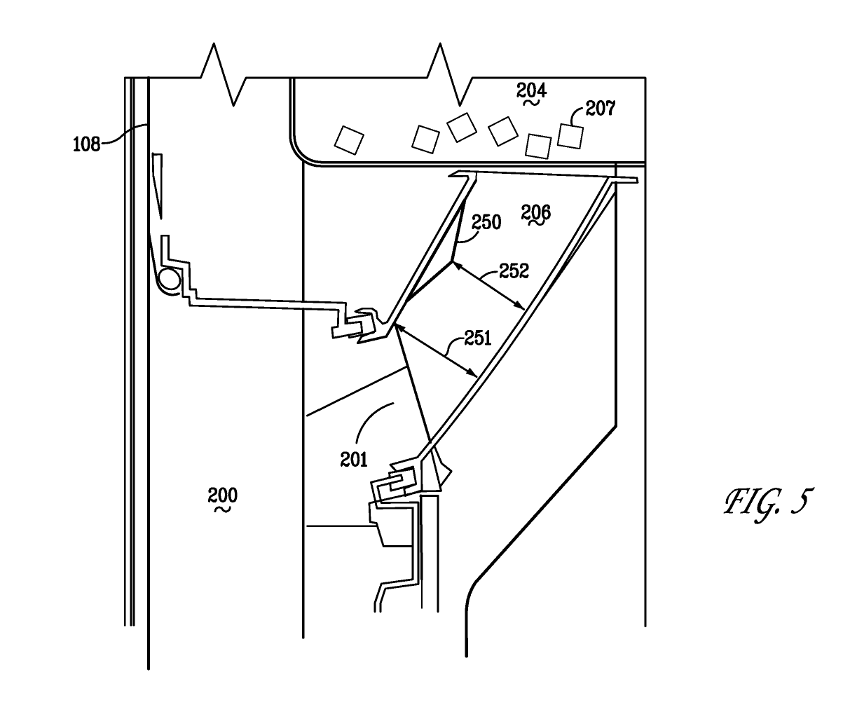

Embodiments of the invention are described below, with reference to the FIGS. 5-10. Throughout the figures, like reference numbers indicate the same or similar components. References to preferred embodiments are for illustration and understanding, and should not be taken as limiting.

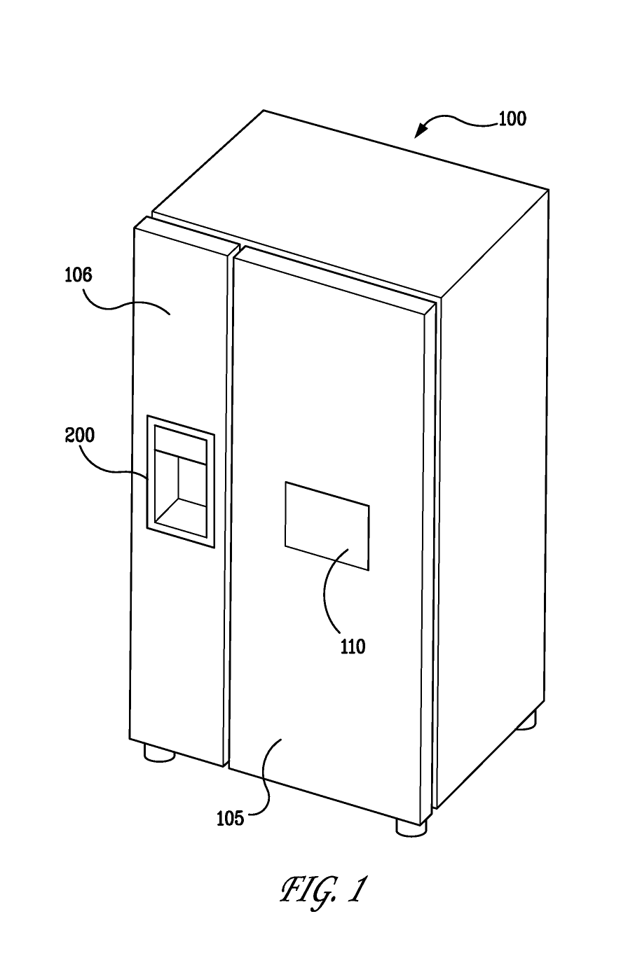

It is contemplated that a dispenser 200 is disposed in a refrigerator 100 containing at least one compartment for the storage of food below the ambient temperature of the surrounding environment. FIG. 1 is a front perspective view of a refrigerator 100. The doors 105 and 108 permit and impede or prevent access to the interior volume of a fresh food and/or freezer compartment 103 shown in FIG. 4. Refrigerator 100 has an ice or ice/water dispenser disposed in the front of door 108. Refrigerator 100 may also have an LCD display or touch screen display 110.

As shown, the refrigerator 100 is a side-by-side refrigerator where a freezer compartment behind door 108 is disposed to the side of a fresh food compartment behind door 105.

It is understood, however, that that the dispenser 200 is not limited to use in any particular refrigerator or one particular compartment, but rather can be disposed in various refrigerators in which the fresh food and freezer compartments are disposed in a variety of positions relative to one another. It is further understood that the refrigerator in which the dispenser 200 is disposed is not required to have one or only one of each of the fresh food and freezer compartments, but rather can include none, or one or more of each of the fresh food and freezer compartments. By way of non-limiting examples, the dispenser 200 can be disposed in a refrigerator that includes one or more fresh food compartments and no freezer compartment, or that includes one or more freezer compartments and no fresh food compartment. Still further, it is understood that the dispenser 200 is not limited to use in a refrigerator, but rather can be disposed in various environments where one or more advantages of the dispenser 200 are provided.

To limit the possibility of injury to users, in a first object of the invention, a restriction is provided to prevent access into the ice chute 206 from dispenser 200 while not impeding the flow of ice down the ice chute 206 to dispenser 200. In one embodiment shown in FIG. 5 the restriction 250 may be a single member in the shape of a fin. The restriction 250 may be formed from any rigid material including but not limited to plastic, foam, metal or PVC. The restriction 250 is made integral with the chute along an inner wall of ice chute 206 preferably the top wall. Alternatively, the chute may be a unitary piece that includes restriction 250. The lateral dimension 251, which is, generally diameter 251 of ice chute 206 should be less then the width 610 of the flat hand probe 600. Further restriction 250 should protrude into the chute sufficiently to reduce the diameter 252 at that location to less then the cupped hand probe 500 diameter 510. Restriction 250 prevents cupped hand access while minimizing the flow restriction of the ice chute 206.

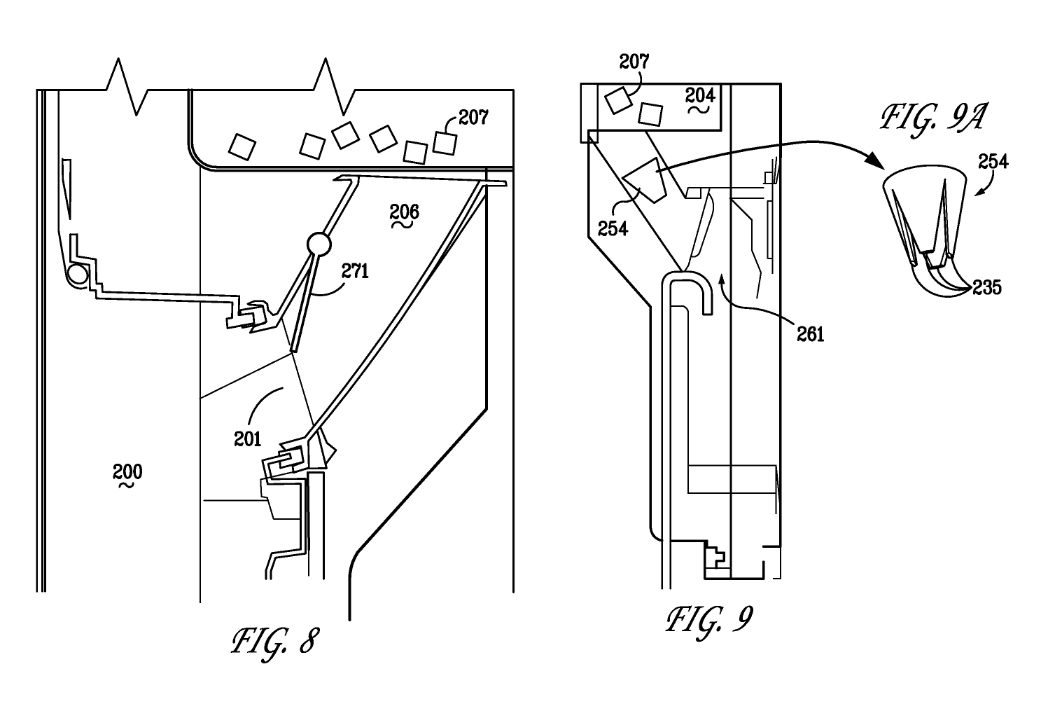

Further benefit can be found where the restriction 250 is spring loaded to move out of the way of ice 207 when dropping through ice chute 206 but remain in position when force is applied from a hand reaching in from dispenser 200. As shown in FIG. 8 restriction 271 may also be shaped as a door for closing flow or access to ice bucket 204 from opening 201. The door 271 of FIG. 8 may either be spring loaded or electrically activated when a user requests ice. In this way, the door would move out of the path defined by the chute 206 to permit ice to flow to a user.

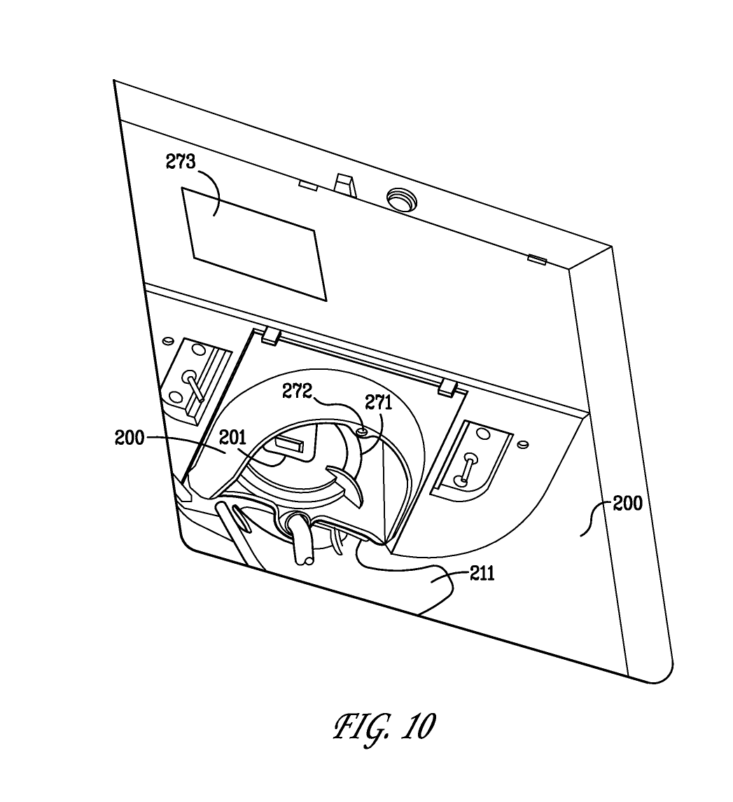

Further restriction 254 could be in the form an expandable funnel as shown in FIG. 9. Restriction 254 has fingerlike projections 253 about the circumference. The projections 253 may move in response to pressure from ice 207 or from an electrical response to a user requesting ice. Where the projections 253 move in response to pressure from the ice 207, the projections 253 may be held in a closed position by either springs or is formed from a pliable material. Where the projections 253 are made to move in response to pressure from downward moving ice, the material must be pliable enough to move in response to light ice pressure from above, however, strong enough to resist the pressure of a hand or other object when inserted from below.

It can be appreciated that restriction 254 need not be within the length of the chute. As shown in FIG. 10, the restriction may be a funnel 270 directing flow of the ice into a vessel held in dispenser 200. The funnel 270 may include a button 271 about the periphery, projecting into the opening 201. The button 271 may be configured as an further restriction to accessing the chute 206. Button 271 may also contain a dispenser outlet 272 for water or other dispensed fluids. In this configuration a user places a vessel under a single location and manipulates a dispense selection panel 273. the dispense selection panel 273 may be in the form of selection buttons and switches, or a touch screen display directing the dispensing of fluids through outlet 272, ice through opening 201 or other selectable items from the dispenser 200.

To limit access to the segment of chute proximate to the ice bucket 204, in another aspect of the invention, the ice chute 206 is curved between the ice bucket 204 and the dispenser 200. Typically, the ice chute 206 is round in shape with generally straight sides 260.

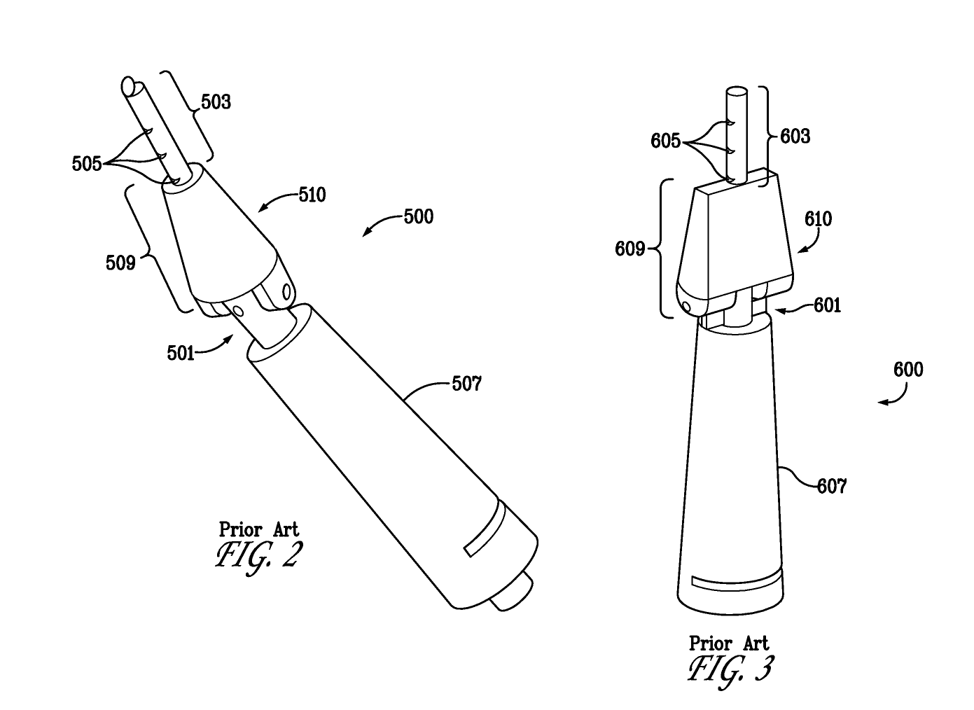

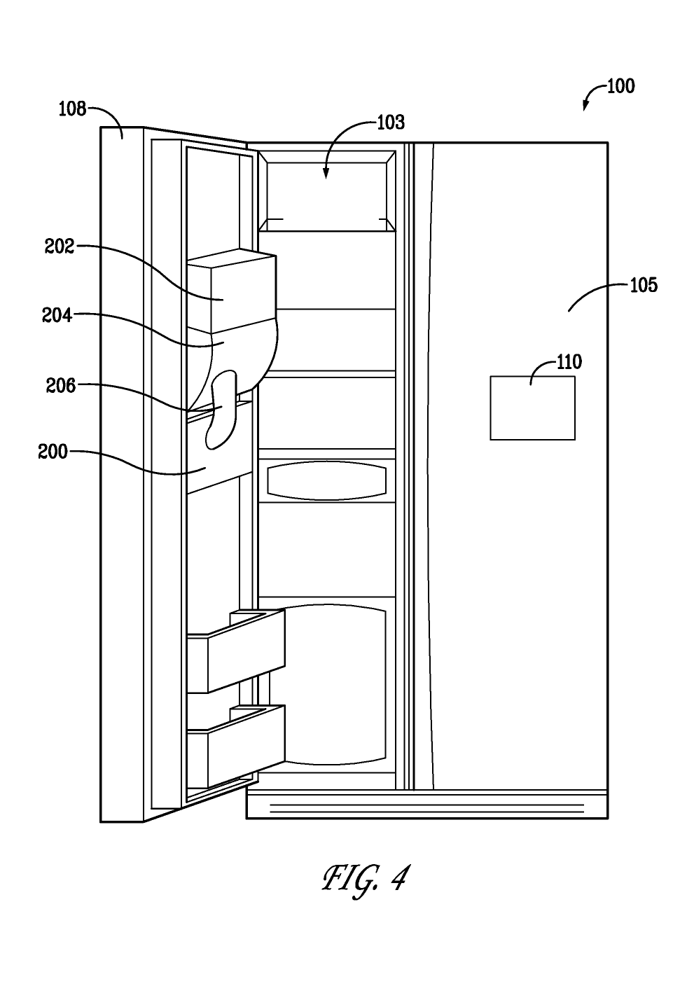

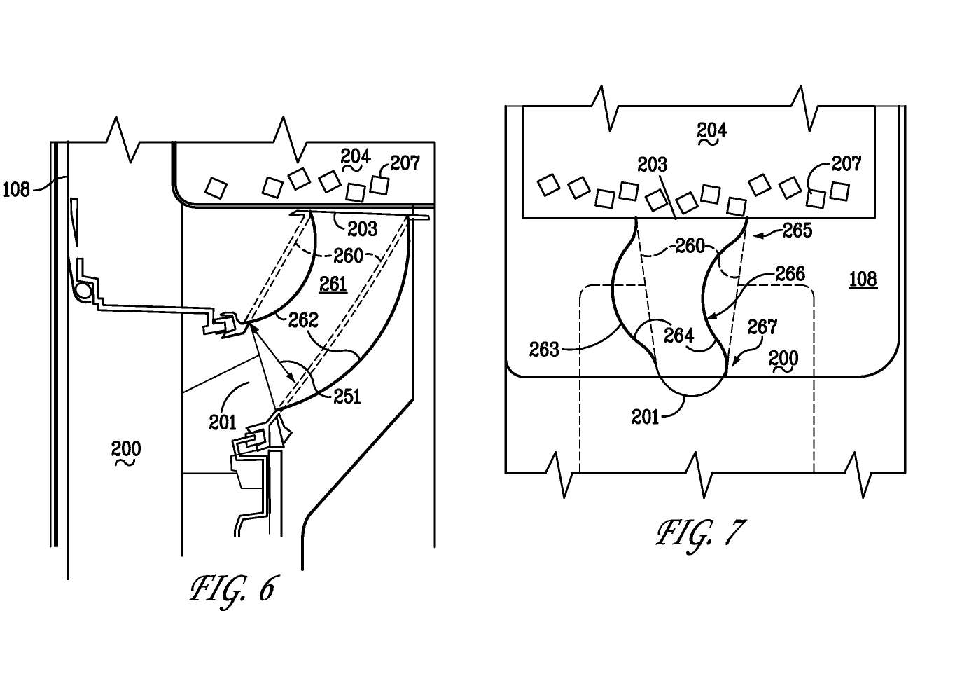

FIG. 6, a side cutaway view of an ice dispenser, indicates a generally hyperbolic or single direction curve of the walls 262 of ice chute 261. Ice 207 enters ice chute 261 from ice bucket 204 at entry 203. Entry 203 is generally vertical in orientation to permit ice to drop without assistance. The curved sides 262 of the ice chute 206 allow a smooth transition from the downward dropping of the ice 107 to the generally straight exit 201. The curve is configured at an obtuse angle where any length across the curve prevents the insertion of a stiff probe such as the probes 500, 600 of FIGS. 2 and 3. However, the curve permits ice 207 to follow the ice chute 261 without binding or becoming lodged.

FIG. 7, a rear cutaway of an ice dispenser, shows an S-shape or multiple direction curve of the walls 264 of ice chute 263. Ice 207 enters ice chute 263 from ice bucket 204 at entry 203. Entry 203 is generally vertical in orientation to permit ice to drop without assistance. However, a first curve 265 changes the direction of the ice to a first side sloping direction that is not vertical. A second curve 266 changes the direction of the ice chute 263 to a second direction generally opposite the first direction. A final curve 267 causes the ice chute to approach exit 201 from a generally vertical direction. Each curve is substantial enough to prevent the insertion of a stiff probe such as the probes 500, 600 of FIGS. 2 and 3. However, each curve also provides a smooth transition to the next segment of the chute to permit ice 207 to follow the ice chute 263 without binding or becoming lodged. The curves are described as generally vertical when viewed from the rear as in FIG. 7. However, when viewed from the side, the ice chute 263 may have a general non-vertical slope starting from an entry 203 configured away from dispenser 200, to exit 201 proximate to dispenser 200.

The exemplary embodiment or embodiments have been described with reference to preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. An ice dispenser comprising:
a user dispense panel comprising; a dispense control and an ice outlet;
a ice storage compartment defining a first interior volume; and
an ice chute flow connecting the ice storage compartment and the ice outlet; the chute comprising:
a first end in flow communication with the ice storage compartment;
a second end in flow communication with the ice outlet; and
a member configured between the first and second ends, the member comprising:
an interior volume in flow communication with the first and second ends;
a flow axis from the first end to the second end; and
a restriction.

2. The ice dispenser of claim 1, wherein the restriction is configured in the ice outlet.

3. The ice dispenser of claim 2 wherein the restriction further comprises a dispenser for fluids.

4. The ice dispenser of claim 1 wherein the restriction is a fin configured along the flow axis.

5. The ice dispenser of claim 4, wherein the fin moves from a first position within the interior volume to a second position out of the interior when a signal is received from the dispense control.

6. The ice dispenser of claim 1, wherein the restriction comprises a door configured perpendicular to the flow axis.

7. The ice dispenser of claim 6, wherein the door is configured to permit flow communication in a first direction from the ice storage compartment to the ice outlet, the door is further configured to prevent flow communication second opposite direction from the ice outlet to the ice storage compartment.

8. The ice dispenser of claim 7, wherein the door further comprises a motor, the motor configured to move the door from a first closed position restricting flow access from the ice outlet to the ice storage compartment to a second open position providing flow communication between the ice storage compartment and the ice outlet.

9. The ice dispenser of claim 8, wherein the motor is activated by a signal from the dispense control.

10. The ice dispenser of claim 1, wherein the restriction comprises a series of finger projections configured as a cone, the cone comprising:
a first end with a first diameter; and
a second end with a second diameter, the second diameter being smaller then the first diameter,
the cone configured along the flow axis of the chute wherein the finger projections are configured to permit flow of ice in a first direction from the ice storage compartment to the ice outlet, the door further configured to prevent flow in a second opposite direction from the ice outlet to the ice storage compartment.

11. The ice dispenser of claim 8, wherein the finger projections are made of a pliable material.

12. The ice dispenser of claim 9, wherein the pliable material is foam.

13. The ice dispenser of claim 1, wherein the restriction comprises a curve of the chute configured along the flow axis of the chute.

14. The ice dispenser of claim 11, wherein the curve comprises a first curve in a first direction and a second curve in a second opposite direction.

15. A refrigerator comprising:
an ice dispenser, the ice dispenser comprising:
a user dispense panel comprising; a dispense control and an ice outlet;
a ice storage compartment defining a first interior volume; and
an ice chute flow connecting the ice storage compartment and the ice outlet; the chute comprising:
a first end in flow communication with the ice storage compartment;
a second end in flow communication with the ice outlet; and
a member configured between the first and second ends, the member comprising:
an interior volume in flow communication with the first and second ends;
a flow axis from the first end to the second end; and
a restriction.

16. The ice dispenser of claim 13, wherein the restriction is configured in the ice outlet.

17. The ice dispenser of claim 14 wherein the restriction further comprises a dispenser for fluids.

18. The ice dispenser of claim 13 wherein the restriction is a fin configured along the flow axis.

19. The ice dispenser of claim 18, wherein the fin moves from a first position within the interior volume to a second position out of the interior when a signal is received from the dispense control.

20. The ice dispenser of claim 13, wherein the restriction comprises a door configured perpendicular to the flow axis.

21. The ice dispenser of claim 20, wherein the door is configured to permit flow communication in a first direction from the ice storage compartment to the ice outlet, the door is further configured to prevent flow communication second opposite direction from the ice outlet to the ice storage compartment.

22. The ice dispenser of claim 21, wherein the door further comprises a motor, the motor configured to move the door from a first closed position restricting flow access from the ice outlet to the ice storage compartment to a second open position providing flow communication between the ice storage compartment and the ice outlet.

23. The ice dispenser of claim 22, wherein the motor is activated by a signal from the dispense control.

24. The ice dispenser of claim 13, wherein the restriction comprises a series of finger projections configured as a cone, the cone comprising:
a first end with a first diameter; and
a second end with a second diameter, the second diameter being smaller then the first diameter,
the cone configured along the flow axis of the chute wherein the finger projections are configured to permit flow of ice in a first direction from the ice storage compartment to the ice outlet, the door further configured to prevent flow in a second opposite direction from the ice outlet to the ice storage compartment.

25. The ice dispenser of claim 24, wherein the finger projections are made of a pliable material.

26. The ice dispenser of claim 25, wherein the pliable material is foam.

27. The ice dispenser of claim 13, wherein the restriction comprises a curve of the chute configured along the flow axis of the chute.

28. The ice dispenser of claim 27, wherein the curve comprises a first curve in a first direction and a second curve in a second opposite direction.
